(19) United States
(12) Patent Application Publication
(10) Pub. No.: US 2012/0015237 A1
(43) Pub. Date: Jan. 19, 2012

(54) SECONDARY BATTERY

(75) Inventor: SUNG-YOUP CHA, YONGIN-SI (KR)

(73) Assignee: SAMSUNG SDI CO., LTD., YONGIN-SI (KR)

(21) Appl. No.: 13/106,602

(22) Filed: May 12, 2011

(30) Foreign Application Priority Data
Jul. 13, 2010 (KR) 10-2010-0067401

(51) Int. Cl. H01M 2/02

(52) U.S. Cl. 429/163

(57) ABSTRACT

An Example relates to a secondary battery including an electrode assembly and an electrolyte contained in a can. The electrode assembly includes an anode plate, a cathode plate and a separator. The electrolyte contains an organic solvent and a lithium salt at a concentration of about 0.5 M to about 1 M in the organic solvent.

### CROSS-REFERENCE TO RELATED APPLICATIONS

This application claims priority to and the benefit of Korean Patent Application No. 10-2010-0067401, filed on Jul. 13, 2010, in the Korean Intellectual Property Office, the entire content of which is incorporated herein by reference.

### BACKGROUND

1. Field of the Invention

The present disclosure relates to a lithium secondary battery.

2. Discussion of Related Art

In a secondary battery, an electrode assembly typically includes an anode plate, a cathode plate, and a separator interposed between the electrode plates. The separator prevents electrical connection between the electrode plates from occurring while allowing electrolyte and lithium salt traveling through the separator. The lithium salt generates electricity by chemical reactions with materials formed on the electrode plates.

### SUMMARY

One aspect of the present invention provides a secondary battery comprising an electrode assembly and an electrolyte contained in a sealed can. The electrode assembly includes an anode plate, a cathode plate and a separator. According to embodiments of the invention, the electrolyte contains a lithium salt at certain concentration to accomplish improved safety without reducing the capacity of the battery. Also, in some embodiments of the present invention, certain level of porosity in the separator accomplishes improved safety without compromising the battery capacity. Further, in some other embodiments of the present invention, the secondary battery achieves high safety, particularly excellent compression properties with certain levels of air permeability of the separator.

The secondary battery comprises: an electrode assembly comprising a first electrode plate, a second electrode plate and a separator interposed between the first and second electrode plates; an electrolyte comprising an organic solvent and a lithium salt at a concentration of about 0.5 M to about 1 M in the organic solvent; and a case accommodating the electrode assembly and the electrolyte therein.

In the secondary battery, the first electrode plate may comprise a first current collector and a first active material layer formed on a portion of the first current collector while the first active material layer is not formed on another portion of the first current collector. The second electrode plate may comprise a second current collector and a second active material layer formed on a portion of the second current collector wile the second active material layer is not formed on another portion of the second current collector.

In the secondary battery, the separator may have a plurality of pores, and wherein porosity of the separator may be from about 25% to about 65%. The porosity of the separator may be about from 40% to about 50%. Air permeability of the separator may be from about 75 sec/100 cc to about 200 sec/100 cc. The air permeability of the separator is from about 75 sec/100 cc to about 100 sec/100 cc.

Still in the secondary battery, the lithium salt is at least any one selected from the group consisting of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl and LiI. The lithium salt is LiPF₆. The lithium salt has a concentration from about 0.8 M to about 1.0 M. The organic solvent may comprise a non-aqueous organic solvent.

Still in the secondary battery, the organic solvent may comprise at least one selected from the group consisting of a carbonate solvent, an ether solvent, an ester solvent, and a ketone solvent. The carbonate solvent is at least one selected from the group consisting of dimethly carbonate, diethyl carbonate, dipropyl carbonate, methylpropyl carbonate, ethylmethyl carbonate, ethlypropyl carbonate, ethylene carbonate, propylene carbonate, 1,2-butylene carbonate, 2,3-butylene carbonate, 1,2-penthylene carbonate and 2,3-penthylene carbonate. The ester solvent is at least one selected from the group consisting of methyl acetate, ethyl acetate, propyl acetate, methyl propionate, ethyl propionate, γ-butyrolactone, γ-balerolactone, γ-caprolactone, δ-balerolactone, and ε-caprolactone. The ether solvent is at least one selected from the group consisting of tetrahydrofuran, 2-methyltetrahydrofuran, and dibutylether. The ketone solvent may be polymethylvinyl ketone.

### BRIEF DESCRIPTION OF THE DRAWINGS

The accompanying drawings illustrate exemplary embodiments of the present invention, and, together with the description, serve to explain various features and embodiments of the present invention.

FIG. 1 is an exploded perspective view of a secondary battery according to an embodiment of the present invention; and

FIG. 2 is a perspective view of an electrode assembly according to an embodiment of the present invention.

### DETAILED DESCRIPTION OF EMBODIMENTS

In the following detailed description, only certain exemplary features and embodiments of the present invention are shown and described, simply by way of illustration. As those skilled in the art would realize, the described embodiments may be modified in various different ways, all without departing from the spirit or scope of the present invention and without departing from the claims appearing later in this disclosure. Accordingly, the drawings and description are to be regarded as illustrative in nature and not restrictive.

In this disclosure, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements. In the drawings, the size or thickness of certain elements may be exaggerated or reduced for the convenience of description and clarity, and may be different from the thickness or size of the actual elements.

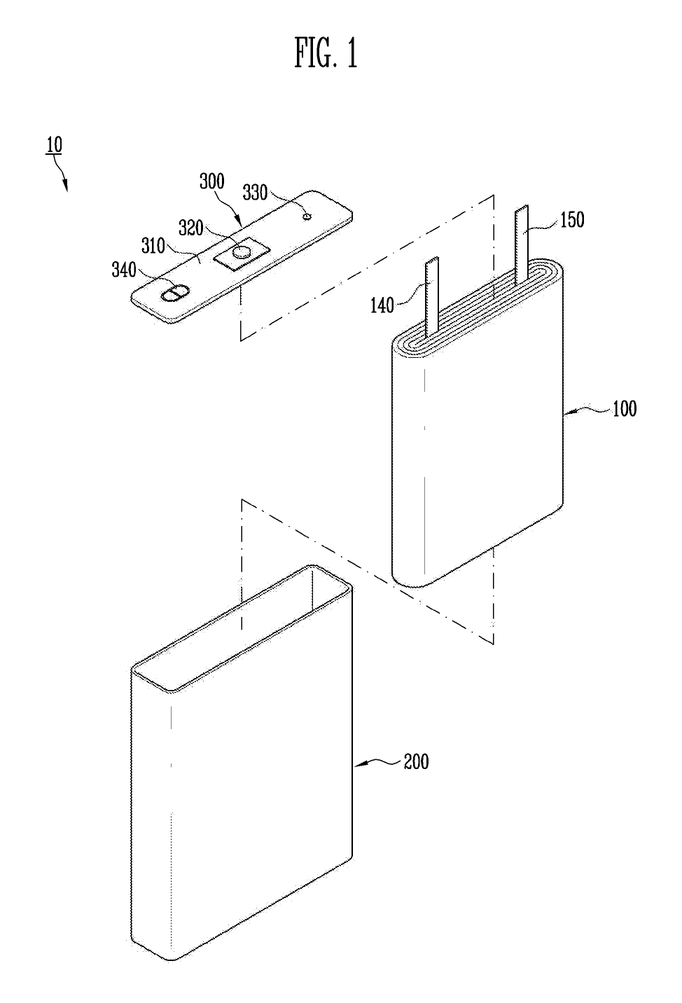

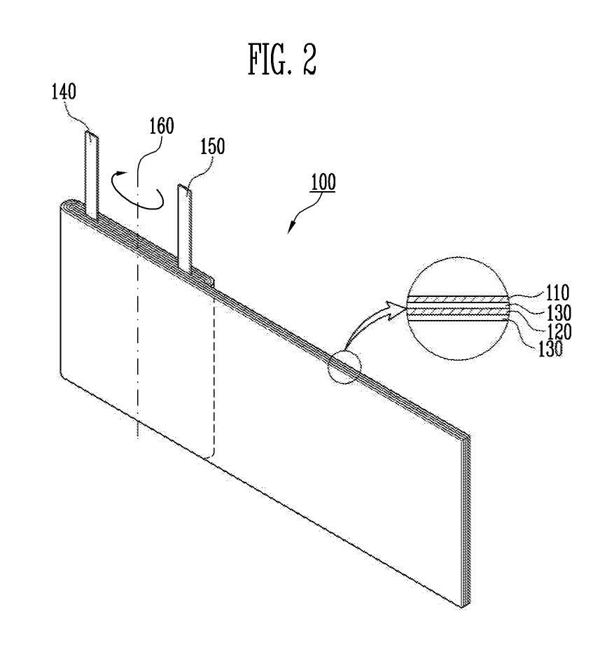

FIGS. 1 and 2 illustrate a secondary battery 10 according to an embodiment of the present invention. FIG. 1 illustrates connections and arrangement of major components of the secondary battery including an electrode assembly 100. FIG. 2 illustrates a detailed view of electrode assembly 100 of FIG. 1.

In FIG. 1, the rectangular secondary battery 10 includes the electrode assembly 100, a can 200, and a cap assembly 300. The electrode assembly 100 is received in the can 200 having an open top. The cap assembly 300 covers the open top of the can 200. The electrode assembly 100 has a multi-layered structure, which will be discussed below in more detail. Two electrode leads (first electrode lead 140 and second electrode lead 150) extend out of the multi-layered structure of the electrode assembly 100. The cap assembly 300 includes a cap plate 310, a cathode pin 320, an electrolyte injection hole 330 and a safety vent 340, which will be discussed later in more detail.

Referring to the enlarged portion of FIG. 2, the electrode assembly 100 includes a stacked structure of a first electrode plate 110, a second electrode plate 120, and two separator layers 130. In the illustrated embodiment, one separator 130 is located between the first and second electrode plates 110 and 120, and the other separator 130 is at the bottom below the second electrode plate 120. Further referring to FIG. 2, the stacked structure is wound, folded or rolled to wrap the earlier wound portion of the same stacked structure. Thus, as the stacked structure wraps the earlier wound portion, the separator 130 appearing under the second electrode plate 120 in the enlarged circle of FIG. 2 will contact the first electrode plate 110 and therefore will also be interposed between the first and second electrode plates 110 and 120.

Although not illustrated, the first and second electrode plates 110, 120 are electrically connected to the first and second electrode leads 140, 150, respectively. The first and second electrode leads 140 and 150 electrically connect the electrode assembly 100, more specifically the first and second electrode plates 110 and 120 to, other components of the battery 10.

Each of the first and second electrode plates 110 and 120 can work as anode or cathode in terms of electrochemistry. For the sake of convenience, however, the first electrode plate 110 is referred to as “anode plate” and the second electrode plate 120 is referred to as “cathode plate” hereinafter. Thus, in some embodiments of the invention, the first electrode plate 110 as illustrated and discussed in this disclosure can be cathode plate, vice versa.

In embodiments, the anode plate 110 includes an anode current collector and an anode active material layer that is formed only on a portion of the anode current collector while not formed on some other portion(s) of the anode current collector. In other words, the anode current collector has a surface on which the anode active material layer is coated and another surface on which the anode active material layer is not coated. In some embodiments, no layer is coated on the portion(s) where the anode active material layer is not formed.

In embodiments, the anode current collector is a thin layer or foil comprising a material having high electrical conductivity. The material for the anode current collector is not specifically limited as long as it does not cause chemical changes or reactions. For example, the anode current collector may be made of aluminum, nickel, titanium, and calcination carbon.

In embodiments, the anode active material layer includes an anode active material, which is a layered compound containing lithium. In embodiments, the anode active material layer further includes a conductive agent for improving conductivity of the layer and a binder for improving bonding between the layered compound and the conductive agent. In embodiments, the anode active material layer is formed by mixing the anode active material, the conductive agent, and the binder with a solvent to provide a slurry and then by applying the slurry onto only a portion of the anode current collector. Preferably, the solvent may be NMP (N-Methyl-2-Pyrrolidone), the anode active material may be lithium cobalt oxide (LiCoO₂), the conductive agent may be acetylene black, and binder may be polyvinylidene fluoride, but they are not limited thereto.

In embodiments, the cathode plate 120 includes a cathode current collector and a cathode active material layer that is formed only on a portion of the cathode current collector and not formed on some other portion(s) of the cathode current collector. In other words, the cathode current collector has a surface on which the cathode active material layer is coated and another surface on which the cathode active material layer is not coated. In some embodiments, no layer is coated on the portion(s) where the cathode active material layer is not formed.

In embodiments, the cathode current collector is a thin layer or foil comprising a conductive metal. For example, the cathode current collector may be made of copper, stainless steel, aluminum, and nickel. In embodiments, the cathode active material layer is formed by mixing a cathode active material, a binder and a thickener with a solvent to provide a slurry and then by applying the slurry onto only a portion of the cathode current collector. Preferably, the solvent may be water, the cathode active material may be graphite, the binder may be styrene-butadiene, and the thickener may be carboxymethylcellulose, but they are not limited thereto.

When graphite is used for the cathode active material, the anode plate 110 corresponding to the cathode plate 120 may have a smaller area than the cathode plate 120. On the other hand, when tin oxide (SnO) or lithium titanium oxide (ITO) is used for the cathode active material, the anode plate corresponding to the cathode plate may have a larger area than the cathode plate.

The separator 130 is interposed between the anode plate 110 and the cathode plate 120. The separator 130 allows ions to move between the anode plate 110 and cathode plate 120 and prevents physical and electrical contact between the anode plate 110 and the cathode plate 120. Therefore, it is preferable that the separator 130 is an insulating thin film having high ion transmittance and mechanical strength. For example, materials used for the separator 130 includes, but not limited to, polyolefin-based polymer films, such as polypropylene, polyethylene, polyethylene/polypropylene, polyethylene/polypropylene/polyethylene, polypropylene/polyethylene/polypropylene, multi-layered films made of one or more polyolefin-based polymer films, a microporous film, fabric, and non-woven fabric. Further, a film coated with polymer resin may be used for the porous polyolefin film.

As described above, the separator 130 provides a path for ions travel between the electrode plates 110, 120 while preventing electrical contact between the electrode plates 110, 120. Therefore, it is preferable that the separator 130 is an insulator having small electric resistance, with an electrolyte impregnated therein. Further, it is preferable that the separator 130 can cut the battery circuit by blocking the micropores when large current flows due to an internal or external short circuit.

The battery performance is influenced by various properties of the separator 130 that includes the thickness, film structure, air permeability, porosity, and pore size. The air permeability and porosity are relatively easily measured. In embodiments, the porosity of the separator 130 is 25% to 65%, and preferably 45%. When the porosity it too small, ions do not move freely between the two electrode plates and may have some adverse effect on the performance of the battery. On the other hand, when the porosity is too high, there is a risk of short circuit and the battery may become less safe.

The air permeability implies time required for passing a predetermined amount of air through a predetermined size of the separator 130 under predetermined pressure. The size of the pores is under μm unit to prevent lithium dendrite from growing and to prevent a short circuit due to foreign substances. The air permeability shows a ratio of the empty portion to the entire volume of the separator 130.

As shown in FIG. 2, the electrode assembly 100 is formed by winding the stacked structure including the anode plate 110, the cathode plate 120 and the separator 130 about a winding axis 160. The electrode assembly 100 then is accommodated in the rectangular can 200, as shown in FIG. 1. In this configuration, an electrolyte is accommodated in the can 200 along with the electrode assembly 100 and the opening of the can 200 is sealed by a cap assembly 300.

Referring to FIG. 1, the cap assembly 300 has a cap plate 310, which includes electrolyte injection hole 330 and safety vent 340. The cathode pin 320 is provided on the cap plate 310 and is electrically connected to the second electrode lead 150 to function as a cathode terminal. Although not illustrated, the second electrode lead 150 is bent, for example, zigzag under the cap plate 310. Although not illustrated, in embodiments, the second electrode lead 150 is typically welded to the cathode pin 320 from under the cap plate 310. On the other hand, in embodiments, the first electrode lead 140 is welded to the cap plate 310. In embodiments, the first and second electrode leads 140, 150 are welded using arc welding or laser welding, while arc welding is more common.

In the illustrated embodiment, the electrolyte injection hole 330 is formed through the cap plate 310 at one side thereof. An electrolyte is injected through the electrolyte injection hole 330, after the cap assembly 300 is placed over the top of the battery case 200. Thereafter, in embodiments, the electrolyte injection hole 300 is sealed by fitting and welding a sealing member. Although not limited thereto, the sealing member is a ball-shaped mother material made of aluminum-containing metal. Further in the illustrated embodiment, the safety vent 340 is formed in the cap plate 310 at the opposite side of the electrolyte injection hole 330. The safety vent 340 is provided to allow discharging of gas from the battery 10, when the internal pressure exceeds certain high pressure.

Although not illustrated, in some other embodiments, the lithium secondary battery of the present invention may be provided in other shapes, including a cylindrical shape and a pouch shape.

As shown in FIGS. 1 and 2, the secondary battery 10 is manufactured by accommodating the electrode assembly 100 within the can 200 along with the electrolyte and then sealing the can with the cap assembly 300. The electrolyte includes lithium salt and non-aqueous organic solvent. The electrolyte may further include one or more additives to improve charging/discharging properties or prevent overcharging. The lithium salt functions as a lithium ion supplier in the battery to allow basic operation of the lithium battery. The non-aqueous organic solvent functions as a medium through which ions involving in electrochemical reactions of the battery travel within the battery.

In embodiments, the lithium salt may be one or more selected from a group of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, LiI and a mixture of two or more foregoing compounds. In embodiments, the non-aqueous organic solvent may an organic compound with one or more substituent groups of carbonate, ester, ether, and ketone. Further, it may be preferable to use a mixture of two or more solvents. For example, a mixture can include a solvent having a high dielectric constant and high viscosity and another solvent having a low dielectric constant and low viscosity, which may achieve smooth ion transmission by increasing dissociation of the ions.

It is preferable to mix and use a cyclic carbonate solvent with a chain carbonate solvent for the carbonate-based solvent in the non-aqueous solvents. For example, cyclic carbonate solvents include ethylene carbonate, propylene carbonate, 1,2-butylene carbonate, 2,3-butylene carbonate, 1,2-penthylene carbonate, 2,3-penthylene carbonate, and vinylene carbonate. The ethylene carbonate and propylene carbonate which have high a dielectric constant are preferable, and the ethylene carbonate is more preferable, when synthetic graphite is used for the cathode active material. For example, chain carbonate solvents include dimethly carbonate, diethyl carbonate, dipropyl carbonate, methylpropyl carbonate, ethylmethyl carbonate, and ethlypropyl carbonate. Dimethly carbonate, ethylmethyl carbonate, and diethyl carbonate are preferable in the substances.

The ester solvents may be methyl acetate, ethyl acetate, propyl acetate, methyl propionate, ethyl propionate, γ-butyrolactone, γ-balerolactone, γ-caprolactone, δ-balerolactone, and ε-caprolactone etc. Further, the ether solvents may be tetrahydrofuran, 2-methyltetrahydrofuran, and dibutylether. The ketone solvents may be polymethylvinyl ketone etc.

### EXAMPLES

Now various features are further discussed by way of examples.

### Example 1

Lithium cobalt oxide (anode active material), polyvinylidene fluoride (binder), and acetylene black (conductive agent) were mixed at a ration by weight, 92:4:4. A slurry including the anode active material was produced by diffusing the mixed substances in NMP (N-Methyl-2-Pyrrolidone). An anode plate was manufactured by applying the slurry onto an aluminum foil having a thickness of 20 μm, and drying and rolling it. An electrode lead (first electrode lead) was attached to the uncoated part of the anode plate.

Synthetic graphite (cathode active material), styrene-butadiene rubber (binder), and carboxymethylcellulose (thickener) were mixed at a ratio by weight, 96:2:2. A slurry containing the cathode active material was produced by diffusing the mixture in water. A cathode plate was manufactured by coating the slurry onto copper foil having a thickness of 15 μm, and drying and rolling it. An electrode lead (second electrode lead) was attached to the uncoated part of the anode plate.

A separator film made of polyethylene having a thickness of 20 μm was interposed between the manufactured anode plate and cathode plate. In this configuration, the porosity of the separator was 45% and the air permeability was 200 sec/100 cc. The electrode assembly was completed by spirally winding the electrode plate and the separator interposed between the electrode plates. The electrode assembly was inserted in a rectangular can, with the first and second electrode leads, which are drawn out from the electrode assembly, at the upper portion. The electrode leads were attached to the lower portion of the cathode plate and the cap assembly and then the opening of the rectangular can was sealed by the cap assembly. A lithium secondary battery was manufactured by injecting an electrolyte through the electrolyte injection hole of the cap assembly and then sealing the electrolyte injection hole. A liquid mixture of ethylene carbonate containing LiPF₆ of 0.5 M and ethylmethyl carbonate (volume ratio, 3:7) was used for the electrolyte.

### Example 2

It was performed under the same conditions of Example 1, except that the electrolyte was a liquid mixture of ethylene carbonate containing LiPF₆ of 0.6 M and ethylmethyl carbonate (volume ratio, 3:7).

### Example 3

It was performed under the same conditions of Example 1, except that the electrolyte was a liquid mixture of ethylene carbonate containing LiPF₆ of 0.7 M and ethylmethyl carbonate (volume ratio, 3:7).

### Example 4

It was performed under the same conditions of Example 1, except that the electrolyte was a liquid mixture of ethylene carbonate containing LiPF₆ of 0.8 M/ethylmethyl carbonate (volume ratio, 3:7).

### Example 5

It was performed under the same conditions of Example 1, except that the electrolyte was a liquid mixture of ethylene carbonate containing LiPF₆ of 0.9 M/ethylmethyl carbonate (volume ratio, 3:7).

### Example 6

It was performed under the same conditions of Example 1, except that the electrolyte was a liquid mixture of ethylene carbonate containing LiPF₆ of 1.0 M/ethylmethyl carbonate (volume ratio, 3:7).

### Example 7

It was performed under the same conditions of Example 1, except that the used separator film had air permeability of 110 sec/100 cc.

### Example 8

It was performed under the same conditions of Example 1, except that the used separator film had air permeability of 100 sec/100 cc.

### Example 9

It was performed under the same conditions of Example 1, except that the used separator film had air permeability of 95 sec/100 cc.

### Example 10

It was performed under the same conditions of Example 1, except that the used separator film had air permeability of 75 sec/100 cc.

### Comparative Example 1

It was performed under the same conditions of Example 1, except that the electrolyte was a liquid mixture of ethylene carbonate containing LiPF_{6 of} 1.1 M and ethylmethyl carbonate (volume ratio, 3:7).

### Comparative Example 2

It was performed under the same conditions of Example 1, except that the electrolyte was a liquid mixture of ethylene carbonate containing LiPF₆ of 1.15 M and ethylmethyl carbonate (volume ratio, 3:7).

### Comparative Example 3

It was performed under the same conditions of Example 1, except that the electrolyte was a liquid mixture of ethylene carbonate containing LiPF₆ of 1.2 M and ethylmethyl carbonate (volume ratio, 3:7).

### Comparative Example 4

It was performed under the same conditions of Example 1, except that the electrolyte was a liquid mixture of ethylene carbonate containing LiPF₆ of 1.3 M and ethylmethyl carbonate (volume ratio, 3:7).

### Comparative Example 5

It was performed under the same conditions of Example 1, except that the used separator film had air permeability of 70 sec/100 cc.

### Comparative Example 6

It was performed under the same conditions of Example 1, except that the used separator film had air permeability of 50 sec/100 cc.

### Comparative Example 7

It was performed under the same conditions of Example 1, except that the used separator film had air permeability of 220 sec/100 cc.

### Comparative Example 8

It was performed under the same conditions of Example 1, except that the used separator film had air permeability of 250 sec/100 cc.

### Capacity Examination and Compression Test

The capacity was examined and compression property was tested in the features of the secondary batteries of the Examples 1 to 10 and the Comparative examples 1 to 8.

1. Capacity Examination

The secondary batteries manufactured by the Examples and Comparative examples were examined for their capacity. The secondary batteries were charged with static current-static voltage at 1 C/2.4V for 3 hours under room temperature by a charger/discharger. Thereafter, the charged secondary batteries were discharged at 1 C/2.75V. The discharging capacity after charging under the conditions was shown as percentage of capacity of the secondary batteries in Table 1 and Table 2.

2. Compression Property Examination

The secondary batteries manufactured by the Examples and comparative examples were charged with static current-static voltage at 1 C/2.4V for 3 hours. The fully charged secondary batteries were placed between two flat surfaces and compressed by a hydraulic ram having a piston having a diameter of 1.25 inch (32 mm). The compression was continuously applied to the secondary batteries of 3000 pounds (13 kN), until the pressure reached to 2500 psi (17.2 MPa). The state of the secondary batteries was checked after the compression test, and the result was shown in Table 1 and Table 2. When the state of the secondary batteries was not accompanied with leakage and thermal runaway, the state was good in the compression test and shown by ‘OK’ in Table 1 and Table 2. On the contrary, when the state of the secondary batteries were fired or broken, the state did not pass the compression test and was shown by ‘NG’ in Table 1 and Table 2.

Hereinafter, the Examples and comparative examples described above are examined on the basis of Table 1 and Table 2.

TABLE 1
Compression test result to lithium salt concentration

| | LiPF6 | Air | | Compression | |
|---|---|---|---|---|---|
| | concentration | permeability | Capacity | test | |
| | (M) | (sec/100 cc) | (%) | OK | NG |
| Example 1 | 0.5 | 200 | 60 | 10 | 0 |
| Example 2 | 0.6 | 200 | 70 | 10 | 0 |
| Example 3 | 0.7 | 200 | 95 | 10 | 0 |
| Example 4 | 0.8 | 200 | 102 | 10 | 0 |
| Example 5 | 0.9 | 200 | 102 | 8 | 2 |
| Example 6 | 1.0 | 200 | 102 | 7 | 3 |
| Example 1 | 1.1 | 200 | 102 | 5 | 5 |
| Example 2 | 1.15 | 200 | 102 | 5 | 5 |
| Example 3 | 1.2 | 200 | 102 | 3 | 7 |
| Example 4 | 1.3 | 200 | 102 | 3 | 7 |

TABLE 2
Compression test result to air permeability

| | LiPF6 | Air | | Compression | |
|---|---|---|---|---|---|
| | concentration | permeability | Capacity | test | |
| | (M) | (sec/100 cc) | (%) | OK | NG |
| Example 6 | 1.0 | 200 | 102 | 7 | 3 |
| Example 7 | 1.0 | 110 | 102 | 8 | 2 |
| Example 8 | 1.0 | 100 | 102 | 10 | 0 |
| Example 9 | 1.0 | 95 | 102 | 10 | 0 |
| Example 10 | 1.0 | 75 | 102 | 10 | 0 |
| Example 5 | 1.0 | 70 | 103 | 5 | 5 |
| Example 6 | 1.0 | 50 | 102 | 0 | 10 |
| Example 7 | 1.0 | 220 | 70 | 5 | 5 |
| Example 8 | 1.0 | 250 | 70 | 5 | 5 |

Table 1 shows the result of using a separator having air permeability of 200 sec/100 cc and examining capacity and compression property of the secondary batteries while changing concentration of LiPF₆ in the electrolyte, that is, concentration of lithium salt.

It could be seen that the compression property was increased with the decrease in concentration of the lithium salt. In detail, in the Examples 1 to 6, the result of testing capacity and compression while gradually decreasing concentration of the lithium salt by 0.1 M, from 0.5 M to 1.0 M was as the follows. It could be seen that a half or more secondary batteries were good in the compression test, when the concentration of the lithium salt was 0.5 M to 1.0 M. In particular, in the Examples 1 to 4, all of the tested secondary batteries passed the compression test, when the concentration of the lithium salt was 0.5 M to 0.8 M. On the contrary, comparing the comparative examples 1 to 4, only 50% of the tested secondary batteries passed the compression test, when the concentration of the lithium salt was increased to 1.1 M or more. Further, it could be seen that the larger the concentration of the lithium salt, the more the number of secondary batteries passing the compression test decreased.

Meanwhile, in the Examples 1 to 3, it could be seen that the capacity of the secondary batteries did not reach 100% of the designed capacity of the secondary batteries, when the concentration of the lithium salt was 0.7 M or less. On the contrary, for the Examples 4 to 6 and the comparative examples 1 to 4, it could be seen that capacity close to the designed capacity was achieved, when the concentration of the lithium salt was 0.8 M or more. However, it could be seen that the capacity showed similar results, even though the concentration of the lithium was increased from 0.9 M to 1.3 M.

Table 2 shows the result or examining capacity and compression property of the secondary batteries while variously changing air permeability of a separator of an electrode assembly, under the same conditions that the concentration of LiPF₆ in the electrolyte, that is, the concentration of lithium salt was 0.1 M.

Referring to Table 2, it could be seen that compression property of the secondary batteries was good, when the concentration of the lithium salt is constant and air permeability of the separator was 75 sec/100 cc to 200 sec/100 cc. In detail, the probability of secondary batteries passing the compression test was increased, when the air permeability of the separator was changed from 200 sec/100 cc to 75 sec/100 cc in the Examples 1 to 6. In particular, as in the Examples 8 to 10, it could be seen that all of the tested secondary batteries passed the compression test, when the air permeability of the separator was 75 sec/100 cc to 100 sec/100 cc. On the contrary, referring to the comparative examples 5 and 6, porosity in the separator increases, when the air permeability of the separator is 70 sec/100 cc or less, such that the anode plate and the cathode plate with the separator therebetween is likely to cause a short circuit. Therefore, it could be seen that the compression property of the secondary batteries was bad, when the air permeability of the separator was 70 sec/100 cc or less. Further, referring to the comparative examples 7 and 8, porosity in the separator is lows, when the air permeability of the separator is 220 sec/100 cc or more, such that heat generated in the secondary batteries is not discharged well. Therefore, it could be seen that a half or more secondary batteries did not pass the compression test.

That is, referring to Table 1 and Table 2, the less the concentration of the lithium salt in the electrolyte, the more the compression property is improved, but the capacity of the secondary battery is decreased, when the concentration of the lithium salt is too low. Further, the larger the air permeability of the separator, the more the compression property of the secondary battery increases, but it could be seen that the compression property of the secondary battery was bad, when the air permeability was 70 sec/100 cc or less, or 200 sec/100 cc or more.

As described above, considering the capacity and compression property of the secondary battery, the concentration of the lithium salt in the electrolyte of the secondary battery is 0.5 M to 1.0 M, preferably, the concentration of the lithium salt is 0.8 to 1.0 M. Further, the air permeability of the separator in the secondary battery is 75 sec/100 cc to 200 sec/100 cc, preferably, 75 sec/100 cc to 100 sec/100 cc.

While the present invention has been described in connection with certain exemplary Examples, it is to be understood that the invention is not limited to the disclosed Examples, but, on the contrary, is intended to cover various modifications and equivalent arrangements included within the spirit and scope of the appended claims, and equivalents thereof.

What is claimed is:

1. A secondary battery comprising:
an electrode assembly comprising a first electrode plate, a second electrode plate and a separator interposed between the first and second electrode plates;
an electrolyte comprising an organic solvent and a lithium salt at a concentration of about 0.5 M to about 1 M in the organic solvent; and
a case accommodating the electrode assembly and the electrolyte therein.

2. The secondary battery as claimed in claim 1, wherein the separator has a plurality of pores, and wherein porosity of the separator is from about 25% to about 65%.

3. The secondary battery as claimed in claim 3, wherein the porosity of the separator is about from 40% to about 50%.

4. The secondary battery as claimed in claim 1, wherein air permeability of the separator is from about 75 sec/100 cc to about 200 sec/100 cc.

5. The secondary battery as claimed in claim 4, wherein the air permeability of the separator is from about 75 sec/100 cc to about 100 sec/100 cc.

6. The secondary battery as claimed in claim 4, wherein the lithium salt is at least any one selected from the group consisting of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl and LiI.

7. The secondary battery as claimed in claim 1, wherein the lithium salt is LiPF₆.

8. The secondary battery as claimed in claim 1, wherein the lithium salt has a concentration from about 0.8 M to about 1.0 M.

9. The secondary battery as claimed in claim 1, wherein the organic solvent comprises a non-aqueous organic solvent.

10. The secondary battery as claimed in claim 1, wherein the organic solvent comprises at least one selected from the group consisting of a carbonate solvent, an ether solvent, an ester solvent, and a ketone solvent.

11. The secondary battery as claimed in claim 9, wherein the carbonate solvent is at least one selected from the group consisting of dimethly carbonate, diethyl carbonate, dipropyl carbonate, methylpropyl carbonate, ethylmethyl carbonate, ethlypropyl carbonate, ethylene carbonate, propylene carbonate, 1,2-butylene carbonate, 2,3-butylene carbonate, 1,2-penthylene carbonate and 2,3-penthylene carbonate.

12. The secondary battery as claimed in claim 9, wherein the ester solvent is at least one selected from the group consisting of methyl acetate, ethyl acetate, propyl acetate, methyl propionate, ethyl propionate, γ-butyrolactone, γ-balerolactone, γ-caprolactone, δ-balerolactone, and ε-caprolactone.

13. The secondary battery as claimed in claim 9, wherein the ether solvent is at least one selected from the group consisting of tetrahydrofuran, 2-methyltetrahydrofuran, and dibutylether.

14. The secondary battery as claimed in claim 9, wherein the ketone solvent is polymethylvinyl ketone.

15. The secondary battery as claimed in claim 1, wherein the first electrode plate comprises a first current collector and a first active material layer formed on a portion of the first current collector while the first active material layer is not formed on another portion of the first current collector.

16. The secondary battery as claimed in claim 1, wherein the second electrode plate comprises a second current collector and a second active material layer formed on a portion of the second current collector wile the second active material layer is not formed on another portion of the second current collector.
